(19) United States
(12) Patent Application Publication
(10) Pub. No.: US 2008/0209458 A1
(43) Pub. Date: Aug. 28, 2008

(54) Optical Drive Comprising Spindle Adjustment Means

(75) Inventors: Johan Jingga, Singapore (SG); Yee Cheok Low, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,804

(22) PCT Filed: Mar. 6, 2006
(86) PCT No.: PCT/IB06/50694

§ 371 Date: Sep. 5, 2007

(30) Foreign Application Priority Data
Mar. 10, 2005 (EP) 05101854.7

(51) Int. Cl. G11B 7/08

(52) U.S. Cl. 720/675

(57) ABSTRACT

The invention relates to set-up adjustment of the optical pickup unit (OPU) (12) position in relation to an optical record carrier in an optical drive. In particular the invention details arrangement of spindles (11) and adjustment means (50A) in the mechanism (10) of the optical drive.

### FIELD OF THE INVENTION

The invention relates to optical drives, in particular to the part of an optical drive where the optical pickup unit (OPU), used to relay optical signals to and from an optical record carrier, is located, and to the mechanism associated with the OPU.

### BACKGROUND OF THE INVENTION

The OPU in an optical drive accesses, via a well defined beam of light, the surface of an optical record carrier placed in the drive, by moving relative to the optical record carrier while the optical record carrier spins above it. Optical information passes between OPU and optical record carrier in the execution of read or write modes, where data is read from or written to the optical record carrier.

The position and orientation of the OPU in relation to the optical record carrier is critical to the success and quality of the read or write processes. The light in the optical drive is manipulated, via the optical path set-up, to produce a light spot, which is then arranged incident on the optical record carrier within a certain distance tolerence. If the light spot is placed too far away from or too close to the optical record carrier, normal operation of the optical drive is not possible.

The OPU is often supported on spindles forming part of a mechanism in the optical drive. The OPU can rest on or slide along the spindles. These spindles are the equivalent of rails or tracks and allow movement of the OPU in a direction radial with respect to the optical record carrier. The height and tilt of the spindles will determine the position and orientation of the OPU in relation to the optical record carrier at different points along the radial axis of the optical record carrier. This in turn positions the light spot. Thus the adjustment of the spindles is of paramount importance to the optimum functioning of the optical drive.

Such an optical drive set-up is known in prior art. Also described in U.S. Pat. No. 5,995,478 is a means of securely fastening the spindles and accurately defining the length of spindle available to the OPU.

In production, after mounting to the optical drive mechanism, the assembly containing the OPU must be further adjusted to get the best position and orientation of the OPU for optimum drive performance. This involves correction of spindle height and tilt.

Most optical drive mechanisms currently available use a “symmetrical adjustment” method to adjust position and orientation and this adjustment is done on the mechanism spindles. The spindles are designed to be resting on top of screws, which are placed at the bottom end of the spindles. The height and tilt of the spindles can then be adjusted by moving the screw up and down (in a direction perpendicular to a reference plane that will coincide with the plane of the optical record carrier). Generally the adjustment is done from the bottom side of the mechanism using a screwdriver, and is thus referred to as “bottom symmetrical adjustment”.

A problem with this type of adjustment is that it is a limiting factor in the overall drive size.

### SUMMARY OF THE INVENTION

It is an object of the present invention to provide an optical drive wherein the adjustment means allow the drive housing and overall drive size to be made smaller, in line with requirements for slimmer optical drives.

This object is achieved according to the invention by an optical drive wherein adjustment means and spindle are arranged to interact via a contact surface, inclined with respect to a reference plane, translating different contact points into corresponding spindle positions.

The inclined contact surface supports or presses on the spindle. As the adjustment means is advanced or retracted with respect to the spindle, the spindle position rises or falls to adjust the height and tilt of the OPU.

Consider also the prior art arrangement of the mechanism with an adjustment screw at the bottom of the spindle, the cap of which defines the lowest portion of the optical drive. If an inclined surface is positioned so that the flat bottom of the inclined surface replaces the adjustment screw, it is clear that where the screw would have a portion extending downwards away from the mechanism, the inclined surface may have no such extension and thus the overall space taken up by the device is reduced.

It should be noted that reference will be made to a spindle placed on top of an inclined contact surface but, in principle, it is also possible for the situation to be reversed such that the inclined contact surface is arranged above the spindle. It is also possible for the inclined contact surface to form an integral part of the spindle itself.

In a further embodiment of the invention, the action of the adjustment means is arranged to result in a movement of the adjustment means in a plane parallel to the reference plane and a corresponding movement of the spindle position in a plane perpendicular to the reference plane. In such a case, the movement is performed within the least amount of space in the drive. Actions at an angle to the plane parallel to the reference plane, could result in the inclined contact plane being moved into the region formerly occupied by the adjustment screw.

In a further embodiment of the invention, the adjustment means comprises a wedge which comprises the inclined contact surface. A wedge has the advantage of an inclined surface and a planar surface. By replacing the adjustment screw head by the planar surface, space requirements in the mechanism are immediately reduced. In addition, movement of the wedge may be initiated by a ratchet mechanism, or other device on which the planar wedge surface could be arranged to rest, which may also be located in a plane parallel to the optical record carrier.

In a further embodiment of the invention the adjustment means comprises a cone point screw which comprises the inclined contact surface. A cone point screw is easily available, and has the advantage of an inclined end coupled with a screw thread for fine adjustment. The spindle may be placed on top of the cone shaped end of the screw. By turning the screw, the cone point is moved in a plane perpendicular to the resulting direction of movement of the spindle.

In a further embodiment of the invention an adjustment range R, describing a maximum movement of a centre point of the spindle, is defined in terms of a spindle diameter D_{S} and a cone point screw diameter D_{CPS}, such that,

R= 1/2 D_{S}+¼ D_{CPS}

Movement of the cone point screw allows various positions of the spindle to be set. These positions form a range of movement of the spindle with a maximum and minimum height. The range of spindle movement required due to the optical drive design must be provided for by the spindle and screw components chosen for the mechanism. For a round spindle and cone point screw, the maximum height is obtained when one component is arranged on top of the other. The minimum height is obtained just before the spindle and cone point would pass each other such that the cone point would pass the widest part of the spindle. By defining the range in terms of the movement of the centre point of the spindle, and taking the relative diameters of the spindle and cone point screw into account, the desired range may be obtained by a choice of components according the relation above.

In a further embodiment of the invention, the inclined contact surface forms an integral part of the spindle. By combining a rounded part of the spindle section with another inclined contact surface part of the spindle section, it is possible to provide adjustment of height while allowing the OPU to rest on or move along the spindle. The inclined contact surface can then be arranged upon another component, such as a flat point screw, to permit adjustment of height and tilt.

In a further embodiment of the invention the mechanism further comprises a tensioning means in contact with the spindle. The tensioning means is advantageous in maintaining a consistent contact and pressure between spindle and inclined contact surface. The tensioning means may be positioned opposite to the point of contact, such as on the opposite side of the spindle to the inclined contact surface, or may be arranged to hold the spindle in place against a reference position, thus preventing slippage or dislocation of the spindle.

In a further embodiment of the invention the tensioning means comprises a spring. A spring is easily available in a variety of strengths to provide the required force or tension, and can be obtained in many sizes, including those small enough to fit into the smaller designs of optical drive. A spring is here also taken to include strips of material under tension. A metal spring in the form of a thin flat metal strip, as could be present in a watch, would be such an example. Another example would be a single piece of tensioned metal at an angle to the spindle held fast at one end and under tension.

In a further embodiment of the invention the mechanism further comprises a guiding means for the spindle. The adjustment of height and tilt of the spindle should, ideally, be effected independently of other movements including lateral translation. Provision of a guiding means can ensure that the spindle is displaced along a single axis of movement only.

In a further embodiment of the invention, the guiding means comprises a restraining wall. A wall close to the spindle is commonly used for fastening purposes in the mechanism of an optical drive. Use can be made of this wall to provide reliable lateral positioning of the spindle while it is adjusted for height and tilt. The wall surface can provide a consistent positioning reference over the full diameter of the spindle and over the full range of spindle adjustment.

### DESCRIPTION OF THE DRAWINGS

These and other aspects of the invention will be further described and elucidated with reference to the drawings, in which:

FIG. 1 is an example of a mechanism comprising spindles and OPU in accordance with prior art.

FIG. 2 is an illustration of means for bottom symmetric adjustment according to prior art.

FIG. 3 is an illustration of means for loading an optical record carrier, arranged in an optical drive according to prior art.

FIG. 4 is an illustration of physical limitations on drive size imposed by means for bottom symmetric adjustment.

FIG. 5 is an illustration of bottom symmetric adjustment in relation to the invention.

FIG. 6 is an embodiment of the invention comprising a cone point screw.

FIG. 7 is an embodiment of the invention comprising a wedge.

FIG. 8 is an embodiment of the invention comprising a cone point screw and related spindle adjustment range

FIG. 9 is an embodiment of the invention comprising a spindle comprising an inclined contact surface.

Reference numerals provided are consistent across all figures, where this is appropriate.

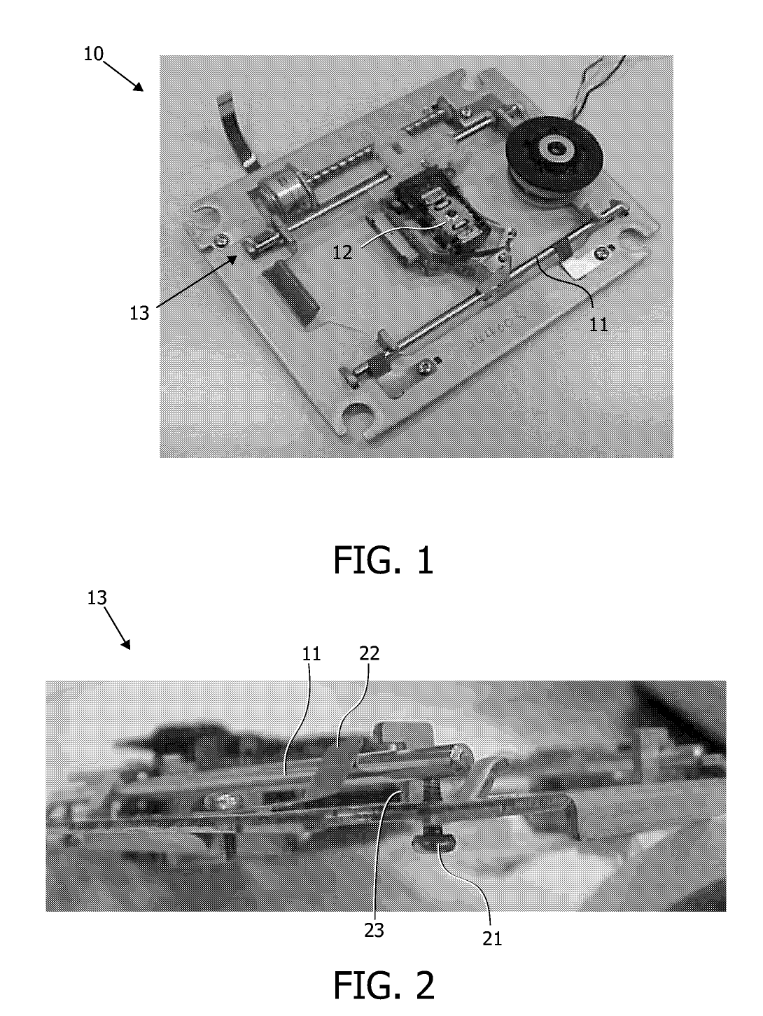

A typical optical drive mechanism is shown in FIG. 1. (The optical drive itself is not shown). This mechanism 10 comprises spindles 11 and OPU 12 in accordance with prior art. The OPU 12 is supported by the spindles 11 and may move along the length of the spindles 11 in order to access a section of an optical record carrier (not shown). An end section 13 of a spindle 11 may be arranged to optimise the spindle position in terms of height and tilt with respect to the optical record carrier.

FIG. 2 shows an enlarged end section 13 of the previous figure. The spindle 11 is held in position and adjusted at this end by a combination of adjustment means or screw 21, a spring 22 and a reference wall 23. The reference wall 23 provides guidance for the spindle in a direction perpendicular to a reference plane (not shown) that coincides with the plane of an optical record carrier (not shown) placed in the optical drive. Also in contact with the spindle 11 is a spring 22 which holds the spindle 11 in contact with the reference wall 23 and with the screw 21. The screw 21 can be adjusted such that the spindle 11 is moved in a direction perpendicular to the plane of the reference plane thus altering the height and tilt of the spindle, which in turn affects the positioning of the OPU (not shown). This figure illustrates the end section 13 but other spindle ends may be arranged and adjusted in a similar manner.

It is clear from FIG. 2 that the head of the screw 21 is arranged beneath the spindle 11. The head thus forms the lowest part of the adjustment means for the spindles and also requires further space beneath it to allow for set-up of the optimum position of the screw. The adjustment of OPU height and tilt in this way is known as bottom symmetric adjustment, according to the positioning of the screw 21.

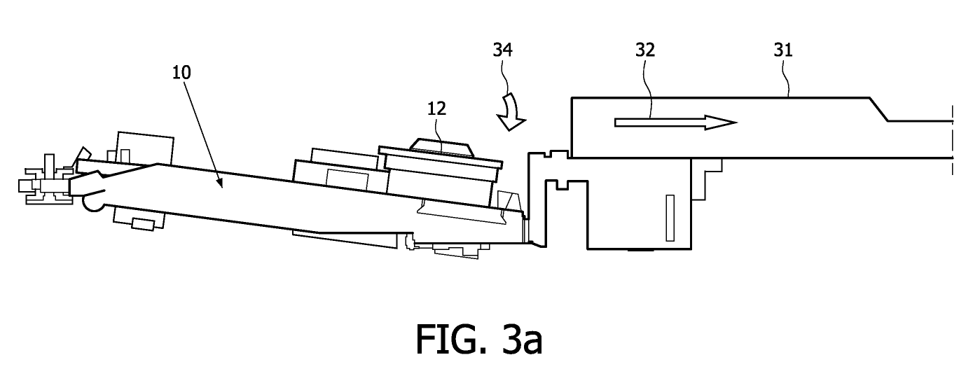

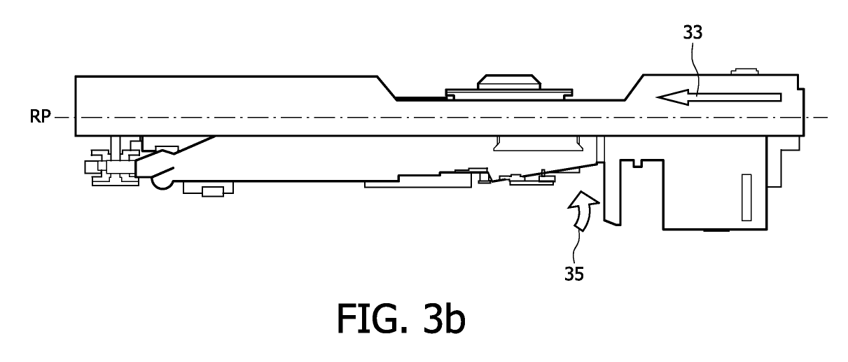

FIG. 3 is an illustration of means for loading an optical record carrier, arranged in an optical drive according to prior art. The figure comprises two parts, 3a and 3b, where FIG. 3a shows an optical drive with loading tray 31 in the open position to allow an optical record carrier (not shown) to be placed in the optical drive and FIG. 3b shows the same optical drive with the loading tray 31 in the closed position. According to prior art, the mechanism 10 is designed in such a way that when the loading tray 31 is opened 32, the front part of the mechanism 10 will be moved down as illustrated by arrow 34. Meanwhile, when the loading tray 31 is closed, the mechanism 10 will lift up as illustrated by arrow 35 and hold the optical record carrier (not shown). The movement of the mechanism 10 in connection with such operations must be allowed for in the design of the optical drive. Adequate space must be provided for upward and downward movements as illustrated by arrows 34 and 35.

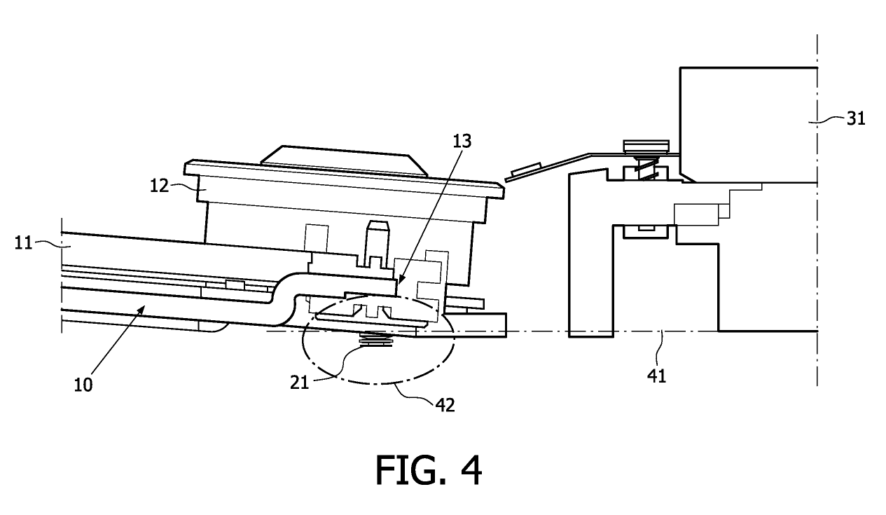

A closer inspection of the mechanism 10 is shown in FIG. 4. The lowest part of the main optical drive mechanism 10 is illustrated by the dashed line 41. The screw 21 falls beneath this line 42. The screw thus becomes the key barrier in the trend towards slimmer and more compact optical drives. These screws cannot be removed because they are important for the symmetrical adjustment, both for permanently fixing the OPU height and tilt set-up in position and for the bottom symmetrical adjustment method which determines that fixed position. Some extra clearance is needed in order to allow the screw positions to be changed during the adjustment process.

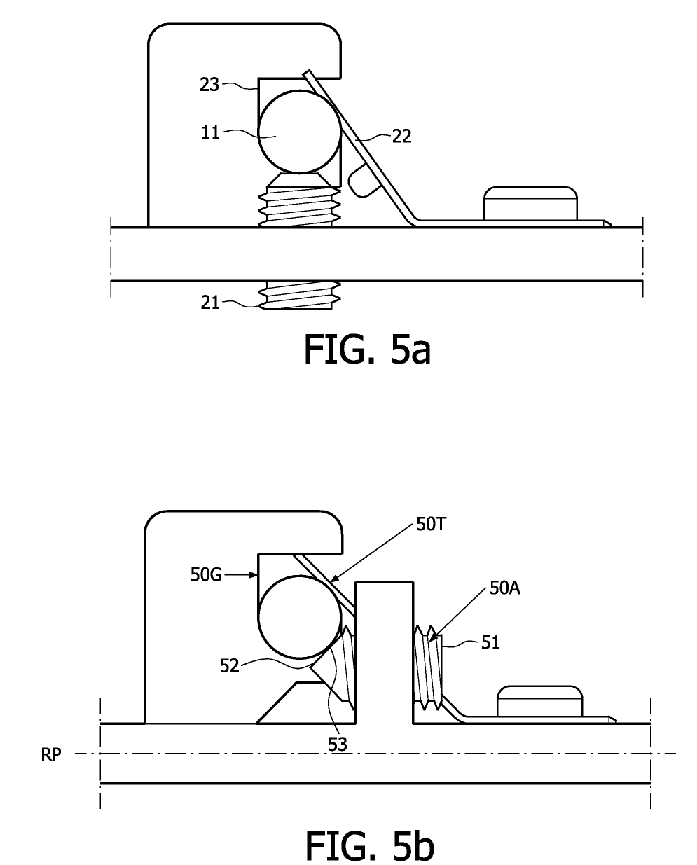

Bottom symmetric adjustment relates to prior art. The invention also relates to an adjustment for OPU height and tilt but the manner and direction of that adjustment are altered. The adjustment in accordance with the invention is named hereafter “side symmetrical adjustment”. A comparison between the prior art and invention is illustrated in FIG. 5, parts 5a and 5b respectively. In FIG. 5a, the spindle 11 is held in place against a screw 21 by a spring 22 and is guided by a reference wall 23, as described above. In FIG. 5b, the screw 21 is replaced by a cone point screw 51. The cone point screw 51 is positioned perpendicular to the direction of screw 21 and parallel to the reference plane RP. The direction of adjustment is now also in the reference plane RP, thereby accounting for the term “side symmetrical adjustment”. The cone point screw 51 and spindle 11 are in contact at a point 53 on an inclined contact surface 52 formed by the cone shaped point of the screw 51. Adjustment of the cone point screw 51 results in a difference in height of the spindle as the inclined contact surface 52 is moved. In the case described here, a change in contact position 53 on the inclined surface 52 also results from adjustment of the screw 51.

Side symmetrical adjustment is here illustrated with reference to a cone point screw. It is also possible to achieve the same adjustment using different adjustment means 50A, such as a wedge 71 or a specially shaped spindle 92. This will be described later. Similarly, different tensioning means 50T may be envisaged to replace the spring 22 and different guiding means 50G may replace the reference wall 23. It should be noted, however, that the inclined contact surface 52 is a key aspect of the invention and that the point of contact 53 may move along this surface 52 or remain stationary on it depending on the means chosen.

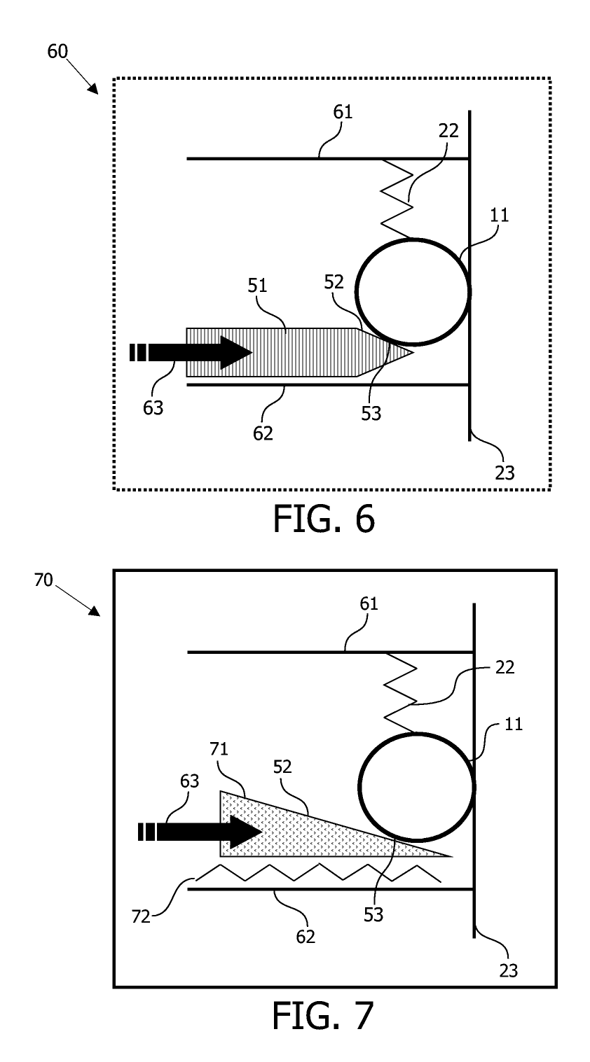

An embodiment of the invention is shown in FIG. 6. This embodiment 60 comprises a cover 61, a base 62, and a side wall used as a reference wall 23 against which a spindle 11 of the optical drive mechanism (not shown) is in contact. Between the cover 61 and the spindle 11 is arranged a tensioning means 50T, which is here illustrated as a spring 22. A cone point screw 51 is arranged on the other side of the spindle 11 from the tensioning means 50T. The combination of cone point screw 51 and tensioning means 50T effectively hold the spindle 11 in a desired position while the reference wall 23 guides the direction of the spindle 11 if it is moved. Changes in the height of the spindle 11 are effected by application of a force or impulse to the cone point screw 51, such as a turning of the screw so as to adjust its position closer to or further away from the reference wall 23. Movement of the cone point screw 51 as indicated 63 causes the inclined contact surface 52 between the cone point screw 51 and the spindle 11 to move and results in a different point of contact 53. The spindle 11 must move along the reference wall 23 in response. Thus the height of the spindle 11 is adjusted, and the tilt with respect to other components of the mechanism may be changed.

An embodiment of the invention is shown in FIG. 7. This embodiment 70 comprises elements similar to those of the previous embodiment 60 but the cone point screw 51 is replaced by a wedge 71. This wedge comprises the inclined contact surface 52 and contact point 53 necessary to implement adjustment of the spindle 11 height and tilt. Further, the wedge may be supported on, for example, a ratchet device 72 to allow it to move in the direction indicated 63.

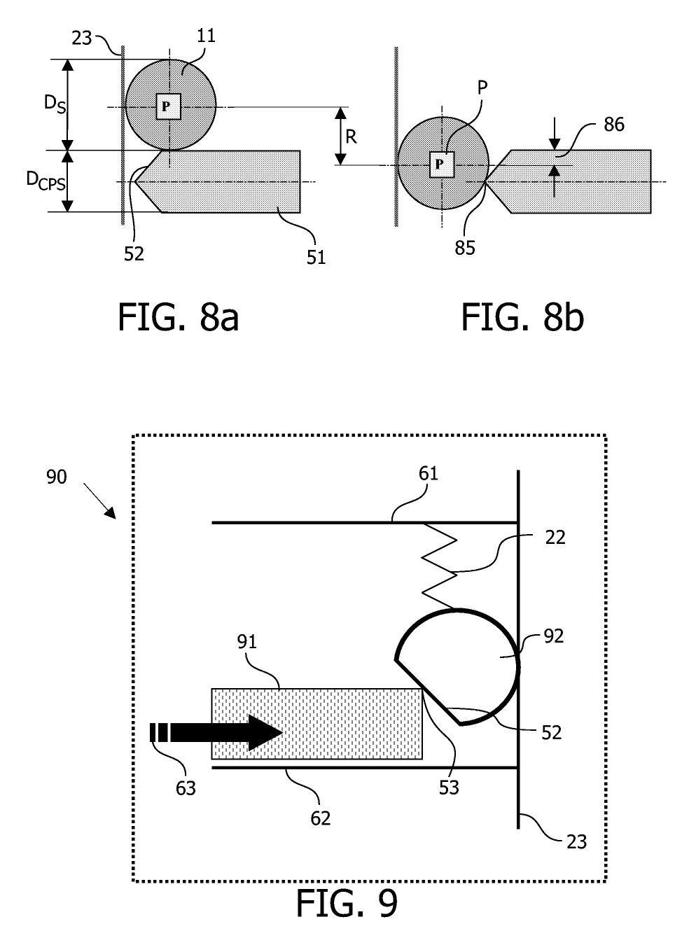

FIG. 8, parts 8a and 8b, illustrate an embodiment of the invention comprising a cone point screw 51 and its related spindle adjustment range R. The spindle 11 is in contact with the cone point screw 51 along the inclined contact surface 52, the exact point of contact depending on the distance of the cone point screw 51 from the reference wall 23. The sizes of the spindle 11 and cone point screw 51 will determine how these two components interact to produce an adjustment in the height of the spindle 11. The spindle 11 may be positioned at different heights depending on the positioning of the cone point screw 51, thus leading to a range of possible positions.

An adjustment range R may be defined for the spindle 11 with reference to the central point P of the spindle 11. The cone point screw 51 has a physical diameter D_{CPS} and the spindle 11 has a physical diameter D_{S}. The spindle 11 is guided by the reference wall 23. When the cone point screw 51 is closest to the reference wall 23, the central point P is at its maximum height, equal to ½D_{S} from the point of contact, with the spindle 11 sitting on top of the cone point screw 51, as indicated in FIG. 8a. As the cone point screw 51 is moved away from the reference wall 23, the spindle 11 moves lower following the inclined contact surface 52. The spindle 11 will stay in contact with the cone point screw 51 as long as the distance from the reference wall 23 to the end point of the cone point screw 85 does not equal or exceed the diameter of the spindle 11. At the lowest possible position, the central point P is at a distance 86 of ¼D_{CPS} from the top of the cone point screw 51. This situation is indicated in FIG. 8b. By taking account of the highest and lowest positions of the central point P, it is possible to derive a relation between adjustment range R and the diameters of the spindle 11 and cone point screw 51:

R=½D_{S}+¼D_{CPS}

The embodiments of the invention described above may be arranged in many orientations. The screw 21, cone point screw 51, wedge 71 or other forms of adjustment means 50A may be placed above the spring 22 or tensioning means 50T, rather than beneath it, for example. Additionally, it is not limiting that the inclined contact surface 52 should be on the adjustment means 50A itself, rather the possibility exists to have the inclined contact surface 52 on the spindle 11. This situation is illustrated in FIG. 9.

FIG. 9 shows an embodiment of the invention 90, wherein the inclined contact surface 52 is present on the spindle 92. The adjustment means 50A comprise a square headed screw 91. The point of contact 53 moves along the inclined contact surface 52 as described previously, thus allowing for height adjustment of the spindle 92.

### LIST OF REFERENCE NUMERALS

10. mechanism
11. spindle
12. optical pickup unit (OPU)
13. end section of spindle
21. screw
22. spring
23. reference wall
31. loading tray
32. direction of movement for loading tray open
33. direction of movement for loading tray closed
34. direction of movement for mechanism down
35. direction of movement for mechanism up
41. lowest boundary of optical drive mechanism
42. position of screw as lowest mechanism component
50A adjustment means
50G guiding means
50T tensioning means
51. cone point screw
52. inclined contact surface
53. point of contact
60. embodiment of the invention
61. cover
62. base
63. movement
70. embodiment of the invention
71. wedge
72. ratchet mechanism
85. end point of cone point screw
86. ¼ diameter of cone point screw
90. embodiment of the invention
91. square headed screw
92. spindle comprising inclined contact surface
RP reference plane
R adjustment range
P central point of spindle

1. An optical drive comprising an optical pickup unit (12), further comprising a mechanism (10) comprising a spindle (11) upon which said optical pickup unit (12) is arranged, the mechanism (10) further comprising adjustment means (50A) for adjusting the spindle, wherein the adjustment means (50A) and the spindle (11) are arranged to interact via a contact surface (52), inclined with respect to a reference plane (RP), translating different contact points (53) into corresponding spindle (11) positions.

2. An optical drive as claimed in claim 1 wherein the action of the adjustment means (50A) is arranged to result in a movement of the adjustment means (50A) in a plane parallel to the reference plane (RP) and a corresponding movement of the spindle position in a plane perpendicular to the reference plane (RP).

3. An optical drive as claimed in claim 1 wherein the adjustment means (50A) comprises a wedge (71) which comprises the inclined contact surface (52).

4. An optical drive as claimed in claim 1 wherein the adjustment means (50A) comprises a cone point screw (51) which comprises the inclined contact surface (52).

5. An optical drive as claimed in claim 4 wherein an adjustment range R, describing a maximum movement of a centre point of the spindle P, is defined in terms of a spindle (11) diameter Ds and a cone point screw (51) diameter D_{CPS}, such that,
R= 1/2 D_{S}+¼D_{CPS}.

6. An optical drive as claimed in claim 1 wherein the inclined contact surface (52) forms an integral part of the spindle (92).

7. An optical drive as claimed in claim 1 wherein the mechanism further comprises a tensioning means (50T) in contact with the spindle (11).

8. An optical drive as claimed in claim 7 wherein the tensioning means (50T) comprises a spring (22).

9. An optical drive as claimed in claim 1 wherein the mechanism (10) further comprises a guiding means (50G) for the spindle (11).

10. An optical drive as claimed in claim 9 wherein the guiding means (50G) comprises a restraining wall (23).
